(19) United States
(12) Patent Application Publication
(10) Pub. No.: US 2008/0291004 A1
(43) Pub. Date: Nov. 27, 2008

(54) Method for tagging objects to form a mutually finding group

(76) Inventors: Michael Regan, Hadlock, WA (US); Peter N. Wright, Port Townsend, WA (US)

Correspondence Address: MICHAEL REGAN, 291 W. HORTON ST., PORT HADLOCK, WA, 98339, US

(21) Appl. No.: 11/804,978

(22) Filed: May 22, 2007

(51) Int. Cl. G08B 26/00

(52) U.S. Cl. 340/505

(57) ABSTRACT

The instant invention is an arrangement wherein a set of devices are enabled to signal each other either individually or as a group, and are attached, inserted, or integrated into various items in order to locate such items when they are lost, or to secure them, or otherwise keep track of them; or also any arrangement and deployment of electronic components, modules, etc (one example of which might be standard RFID chips such as are used in inventory control), such that a group of important but easily lost items, (such as wallet, keychain, calendar, and briefcase) can signal to one another so that a lost item can be “beeped” so that its whereabouts can be discovered. Additionally, the devices may be configured to signal the others if or when mutual contact is broken.

### FIELD OF THE INVENTION

This invention relates to attaching electronic communication devices to items such as phones, wallets, key chains, etc., to form a mutually finding group.

### BACKGROUND OF THE INVENTION

The use of an electronic means to locate objects is well known in the art. For example, radio frequency object locator systems exist for enabling the location of misplaced objects.

One such locator system typically includes several color-coded object tags, each of which can be attached to an object, such as a set of keys or a television remote control. Such systems typically include a base having a color-coded button associated with each color-coded tag. The base may have a space next to each of the buttons in which a user can enter text describing the object to which the associated tag is attached. A user can press the button on the base to find an object that has been misplaced, as the base emits a radio frequency signal which is specific to the tag attached to the object. The tag responds to the radio frequency signal by emitting an audible signal, such as a beep, allowing the user to locate the missing object. Such a system is described in U.S. Pat. No. 6,570,504 to Rabanne and Ivie.

Such systems are generally short ranged, typically around 30 feet, and are limited to a small number of objects which is typically around four. Some systems use different radio frequencies for each object to be located, or use a separate carrier modulation code for each object. Still others have a pre-programmed code that the base and tag can use for identification. These configurations restrict the number of different tags that can be used. For example, U.S. Pat. No. 6,297,737 to Irvin utilizes a Bluetooth transceiver located in a mobile terminal such as a cell-phone, which forms the master to a Bluetooth piconet. The system may include up to seven slave Bluetooth devices in addition to the master device. The slave Bluetooth devices may be tags that can be polled to emit an audible signal when knowledge of their location is desired. The tags may also transmit a “found” signal to the master device. While the master device can display on an LCD display that a desired tag has been located, the user must track down the tag by listening for the audible signal emitted by the tag. The master device cannot give any indication of proximity to the object. Bluetooth operates in the 2.4 GHz frequency band, which is a government regulated and crowded frequency band. In addition, the number of tags that can be searched for this type of system is extremely limited because of the inherent limitation on the number of devices that may be used in a Bluetooth piconet.

Systems have been proposed for the location of a larger number of items, such as document files. U.S. Pat. No. 5,798,693 to Engellener describes a system including a tag associated with each object, and a plurality of interrogation signal generators. The signal generators are placed in each room or area of a user's premises, which may be a store or office, and can be caused by a central controller to poll each object tag located within their immediate vicinity. Each tag can include a unique identification code, and may include a resonance circuit that can emit a responsive signal to the signal generators. In another example, U.S. Pat. No. 5,689,238 to Cannon, Jr. et al. describes a system in which an electronic object tag is identifiable by a unique response code. The response code may be keyed into a portable interrogator, which emits a radio frequency signal including the response code of the desired tag. The tag modulates its reflection of the interrogator's radio signal to allow the interrogator to indicate its relative proximity to the tag. Location markers may be used to amplify the signals and to provide an indication of the location of the object. Notably, both of these described systems have very short ranges of operation, and hence require intermediate signal amplifiers to operate effectively.

These systems have other disadvantages and limitations, including significant installation expense and operation difficulties. In particular, a user may not wish to constantly poll for the location of all objects having tags, but may wish to simply locate one particular object that is missing. In addition, different users need flexibility in identifying the objects to be located, because entering the tag identification code to locate an object is not intuitive to a user. It is time consuming for a user to have to look up the tag identification code for the object they wish to locate. In addition, the user may not have ready access to the list or database in which they have stored or listed the tag identification codes, or even to the master finding device itself, further delaying or preventing the recovery of the lost object.

It is therefore desirable to produce an improved object locator system, which allows the user a significant degree of flexibility in its set-up and use.

### SUMMARY OF THE INVENTION

The instant invention solves the problems of limited object numbers, limited range, and obviates the need for a master finder, as each of the objects in the group is capable of finding any of the others. The present invention covers systems in which each potentially lost item can serve ad hoc as the master device for finding any of the others in its group.

Electronic circuitry is arranged to form a set of devices each of which contains electronic identifiers and signaling circuitry such that, when the user activates a search signal from any one of the devices, any or all of the others will respond. The response can be in the form of A) an audible beeping noise when there is sufficient battery power available, B) a visible signal, such as a flashing of a light emitting diode, or C) an electronic signal which can then be detected in terms of its strength, direction, range, or if GPS-enabled, its actual location, or excited by the sending device if the responder has a passive circuit; or any combination of the above. The use of GPS is well known in the art. The desired circuitry can be achieved using ordinary and readily available industry standard parts.

Each member of a group of devices may be equally capable of sending and receiving, or some members may act as super-senders, having additional battery power and circuitry capable of displaying location information, time of last communication, item identity etc; for example, on a screen.

The instant invention has advantages of the range of typical transmitters and receivers and eliminates the need for a master unit. Moreover, range may be greater in that by communicating device to device, members of a far-flung group might communicate with each other over distances greater than possible for any of the group's individual receiver-transmitter pairs.

The subject matter of the present invention is particularly pointed out and distinctly claimed in the concluding portion of the specification. However, both the organization and method of operation, together with further advantages and objects thereof, may best be understood by reference to the following description taken in connection with accompanying charts.

### BRIEF DESCRIPTION OF THE DRAWINGS

FIG. 1 is a block diagram of a four-object group showing the 6 possible interrelationship location queries.

FIG. 2 is a diagram of the items in a group when they are located at sufficient distances from each other that each can only communicate with one or two nearest items.

FIG. 3 is a diagram of an item out of contact with the others.

### DESCRIPTION OF THE PREFERRED EMBODIMENT

To achieve the instant invention, each object in a group will have an implanted device, not necessarily part of the working mechanism of the object, that performs the finding, response and reporting function.

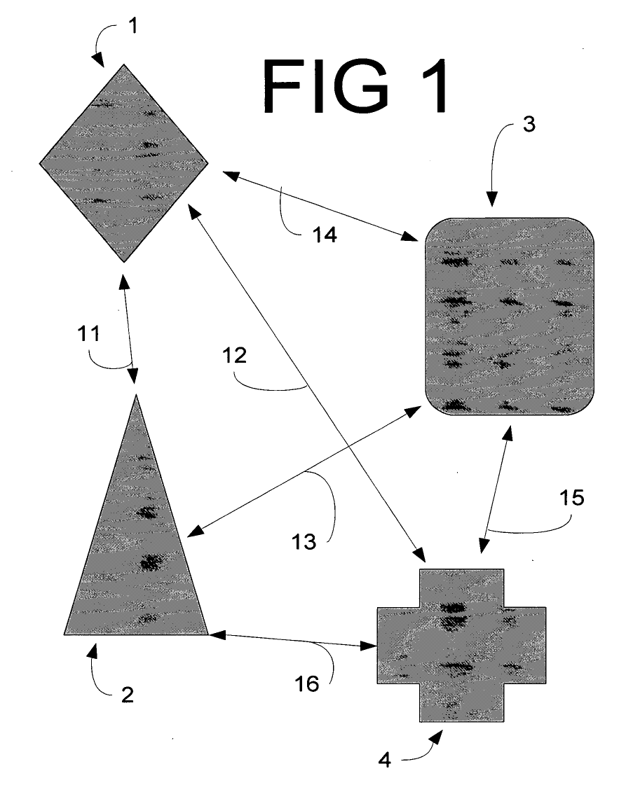

Normally, members of a group can be in communication with all the other members of their own group. FIG. 1 is a group, showing items 1,2,3,4 in contact, each with all of the others. The lines, 11,12,13,14,15,16 depict communications between the items. Item 1 can be in communication with items 2,3, and 4, and item 2 is in communication with items 1,3, and 4, and so on. But, the above items could be restricted from communicating with items in other groups, or with designated subgroups of items.

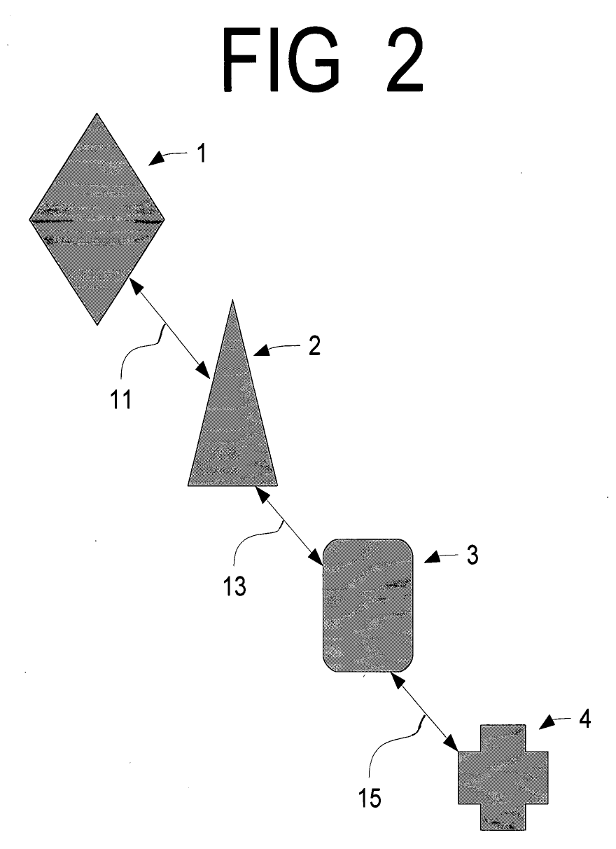

FIG. 2 illustrates the items in a group when they are located at sufficient distances from each other that each can only communicate with one or two nearest items. Item 1 to 2, item 2 to 1 and 3, item 3 to 2 and 4, and item 4 to 3. Item 1 may still be in communication with item 4 by using the others as relays.

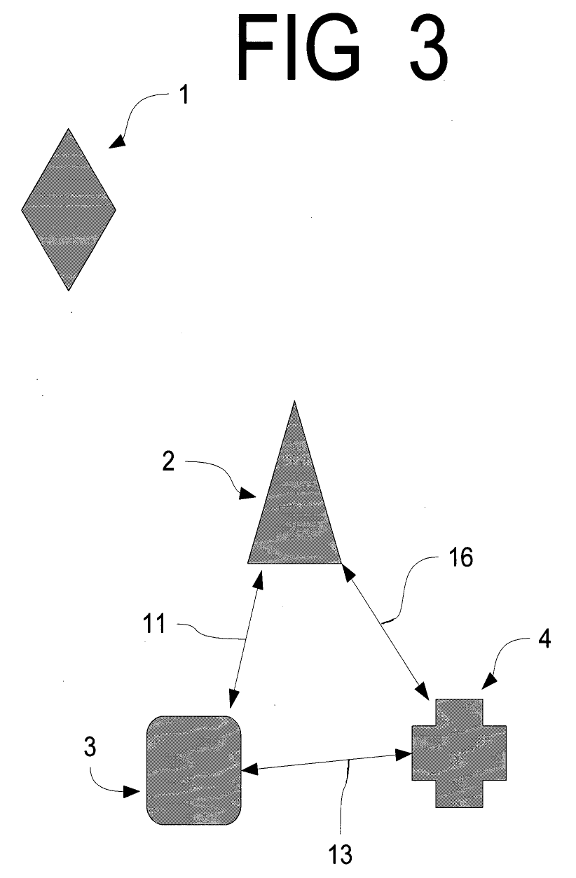

FIG. 3 shows an item out of contact with the others. In this instance, it may be beeping, or there may be no alert feature, or it has failed to engage, or it has been ignored. But, there may be a record residing on one or more of the remaining members of the group noting the time the separation occurred. This information can be accessed in order to remind users of where they might have been at the time of the separation. In addition, a “within range” signal may sound or flash, giving an increasing volume or frequency of “beeps” as the lost item is approached.

The instant invention uses an arrangement of commonly available industry standard electronic circuitry, boards, standard integrated circuits, modules (passive and active circuits, such as RFIDS, large scale integrated circuits, programmable gate-arrays) and the like, in devices containing electronic identifiers and signaling circuitry such that when the user activates a search signal from any one of the devices, any or all of the others may respond.

The response can be in the form of: A): an audible beeping noise when there is sufficient battery power available, B): a visible signal, such as the flashing of a light-emitting diode, or C): an electronic signal which can then be detected and measured in terms of its 1) strength, 2) direction, and/or its 3) range, or 4) if Global-Positioning-Signal-enabled, its actual location; or various combinations of any of the above. Each of the set of devices may be equally capable of sending and receiving. In addition, some members may be super senders, having additional battery power and circuitry capable of displaying location information, item identity, etc, on a screen.

To endow a set of objects with a unique identifier code, so that only specified self-identifying objects respond to any particular signal it is recommended that IP (Internet Protocol) be used.

An additional option is to configure the devices so that the active circuits continually signal by sending out identifying information in short pulses on a periodic basis (every few seconds, for example, or only every minute or so if power-saving is an issue). Each device may then be configured such that its active circuitry promptly alerts the user and/or the other devices (by giving a coded audible beep signal, or by flashing an LED, or signaling the other devices, for example) when contact with one or more of the other devices in the group is lost (as when the expected signal is not received three times sequentially). Thus a device accidentally left behind would “complain,” as would the other devices in the group. Logic circuitry may be included to determine whether the lost item signals the user or only certain of the other devices.

If this “complain” option is incorporated into the design, an easy way should be provided for the user to turn this option on and off, including a “time-out” sequence to protect the user from forgetting to turn the alert feature back on again once the need for quiet passes. Optionally, the devices may resume all temporarily disabled functions automatically by means other than simple timing. Logic elements for sensing change of location such as switching from one signal source to another (cell tower, different group member, GPS signal if available, etc.) would be one example of such an option.

Protective Inconspicuousness: It is recommended that devices be configured such that the user may specify that if certain items lose contact with all the other devices (items) of their group that they shut down all audible or visual signals designed to attract user attention until such capability is re-established by a specific communication from one of its own group, so that only its owner may find it; thus to prevent a wallet, for example, from proclaiming itself to all and sundry when it has been left behind or mislaid. The user may want this feature to be expressed only in particular items in a group.

Where memory and available power permit, one or more items of the group may record and report the last GPS data received from the item before contact was lost, or in simpler cases may record and report the time elapsed since the last signal, thus allowing the user to know how far to backtrack in searching.

Units may be configured with a combination of more memory and GPS or other means of logging location so that a history of location reports by various members of a group may be recorded by group members so equipped. These reports may be used for applications other than merely finding lost items: for example, proving that a hazardous shipment did not stray from its assigned route.

Members of a group can be set up such that one or more group members can communicate with other systems (a security system, automatic truck log, etc.) for such uses as alerting a driver or warehouse worker that part of a multi-package shipment has become separated or that pilferage from a palletted or containerized group is taking place.

To make such a system usable with anti-shoplifting door security at a large retailer, for example, at check out the item could be automatically switched from “membership” in a store group to membership in the new owners existing group.

Group membership could be switched in such fashion all the way from manufacturing through the distribution chain.

Items equipped with WiFi, WiMax, Bluetooth or other means of communicating outside the group with other similarly equipped devices may be programmed to seek and make connections using any available resources within range, to send and receive information over the Internet, a virtual private network, or other networks.

Items or whole groups thus equipped may also be programmed using resources available on the Internet, including, for example, a web page provided by the manufacturer to accommodate users wishing to quickly configure a group using default settings or settings customized by the user using utilities provided on the web site.

A typical package of devices might therefore contain an item consisting of a device built into a USB stick or other external memory unit or “stick” to facilitate communicating programming (instructions) to the group using a computer, PDA, or whatever other networked equipment may be convenient for the user.

In circumstances wherein one of the items is a wireless communication unit such as a PDA (personal digital assistant) or telephone, the circuitry for enabling the unit to become a mutually finding item in a group may be integrated into the design of the product itself. In such cases the item may have significantly greater capacity for communicating and recording communications with other members of its group, and may also be utilized for more elaborate user interactions and for communicating with other more distant groups. These other groups could then themselves become “items” and thus members of a larger group. Another way to look at this arrangement would be that a group with such a super-enabled member could then become a subset of one or more super-groups.

A similar approach may be taken with devices capable of WiFi, WiMax, or other wireless communication protocols originally devised for other applications.

The devices may be powered or passive (that is, excited by a radio frequency or infrared signal from another device seeking to communicate with it).

Power sources may include, but are not limited to the class of batteries, solar panels, or kinetic devices utilizing the movements of the user or the devices themselves, such as inertial magnet generators or flexed piezo-electric materials, etc.

Elements of a typical Beeper Communication Unit

| Name | Connection | Function |
|---|---|---|
| receiver element | from group members (external) | collects reports |
| transmitter | to group members (external) | sends reports |
| element | | |
| memory unit | to and from other | saves information |
| | module(s) (internal) | from other members |
| user interface | input: mechanical transducer(s) | user instructions e.g. |
| element | output: flash, beep, or vibrate | find wallet, silent |
| | to alert user to status change | mode, etc. |
| user | global: to all other | signals other |
| communication | group members, | group member(s), |
| element | security systems, Internet, etc | other groups, and/or |
| | | others outside of |
| | | group |
| power element | battery, solar panel, generators, | energize circuitry |
| | excitation by external | |
| | rf signal, etc. | |

### Terms Used

“Beeper;” convenient means of referring to the signaling devices of the instant invention.

“Beeped;” here defined as signaled in such a way as to be caused to signal back either audibly or by radio emission, light, or other signal.

“group” (of items): those items that have modules (devices) installed allowing them to recognize each other, exclusive of other groups or individual items.

“RFID;” Radio Frequency Identifier to the industry, used here in a broader way to mean 22 not just inventory stuff, but a broad class of active and passive circuits devised for a broad range of uses in a multiplicity of industries and applications.

“Device;” the combination of sending and receiving equipment (both active and passive) enabling mutual location, capable of being either integrated into an object such as a wallet, or attached to an object such as a pair of glasses.

“Item;” any of the objects to which the modules or devices are attached or embedded.

“Module;” a chip, daughterboard, circuit board, or other subassembly, especially an off-the-shelf component for incorporation into more complex devices or circuits.

“Group;” sundry items assigned to or associated with each other, by dint of installation of “devices” capable of mutually keeping track of and/or finding each other.

“Member;” item or device assigned to, or associated with, a group.

### OTHER EMBODIMENTS POSSIBLE

While several embodiments of the present invention have been shown and described, it will be apparent to those skilled in the art that many changes and modifications may be made without departing from the invention in its broader aspects.

I claim:

1. The method of communication among devices wherein any member item in a group may be used to find any other members of said group.

2. The method in claim 1 wherein said member items of said group are selected from a class of PDA's, phones, remote control units, computers, keyboards, monitors, credit cards, passports, documents, wallets, purses, calendars, planners, notebooks, items in a truck or trailer, items on a pallet, and items in warehouse or cargo container.

3. The method in claim 1 wherein recordings are made of reports received by said members of a group which may include time since last communication and last reported location of said members of a group.

4. The method in claim 1 wherein a device that has been silenced or temporarily disabled re-enables itself after a pre-set or user-programmed period of time or when said device senses that it is in a new location by change of communication status, cell, GPS indication, or other means of self-location.

5. The method in claim 1 wherein said items may be programmed to communicate with other items not necessarily of their own group in order to receive reports which are triggered when a member of said group fails to communicate; or in order to use the Internet, a virtual private network, or other networks to send information back to said group or a user, or another as instructed; and to receive instructions including programming over the Internet, a virtual private network, or other networks.
